(19) United States
(12) Patent Application Publication
(10) Pub. No.: US 2025/0353172 A1
(43) Pub. Date: Nov. 20, 2025

(54) DETERMINATION OF NOZZLE TIP ALIGNMENT IN MANUFACTURING

(71) Applicant: TOYOTA MOTOR ENGINEERING & MANUFACTURING NORTH AMERICA, INC., Plano, TX (US)

(72) Inventor: Joseph D. Gieske, Erlanger, KY (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi, Aichi-ken (JP)

(21) Appl. No.: 18/665,730

(22) Filed: May 16, 2024

(51) Int. Cl. B25J 9/16; B25J 11/00

(52) U.S. Cl. CPC B25J 9/1664; B25J 9/1679; B25J 11/005

(57) ABSTRACT

A nozzle tip on a vehicle manufacturing robot remains on the robot while being checked for alignment. A robotic arm is moved to a pre-programmed alignment position such that the nozzle tip is adjacent to an alignment fixture secured to a stationary member. Then, a determination is made as to whether the nozzle tip is aligned with the alignment fixture such that an axis of the nozzle tip is collinear with an axis of the alignment fixture.

### FIELD OF THE DISCLOSURE

The present disclosure relates generally to manufacturing systems and, more particularly, to systems and methods used to determine alignment of a nozzle tip on a robotic arm.

### BACKGROUND

Robotic nozzle tips are used in the manufacturing process to apply chemicals or other substances to vehicles. Often, the nozzle tips can become bent or otherwise damaged which leads to application errors and costly downtime.

Conventional approaches to troubleshooting application errors has been time consuming and inefficient. Operators can tell the nozzle tip is bent, but do not know in which direction the nozzle tip is bent or to what extent. Thus, operators have to guess at how exactly to re-calibrate the tip, which leads to mistakes and non-uniformity between calibrations.

### SUMMARY

In consideration of the above-described disadvantages, the present disclosure provides systems and methods to determine alignment of a nozzle tip on a robotic arm. In a generalized method, a robotic arm is moved to a pre-programmed alignment position such that the nozzle tip adjacent to an alignment fixture secured to a stationary member. The nozzle tip has a first end and the alignment fixture has a second end, the alignment fixture being in a retracted position to thereby create a first distance between the first end of the nozzle tip and the second end of the alignment fixture to prevent collision between the nozzle tip and alignment fixture. Once the nozzle tip has been positioned adjacent to the alignment fixture, the alignment fixture is extended such that a second distance is placed between the first end of the nozzle tip and the second end of the alignment fixture, the second distance being less than the first distance. Then, a determination is made as to whether the first end of the nozzle tip is aligned with the second end of the alignment fixture such that an axis of the nozzle tip is collinear with an axis of the alignment fixture.

In an alternate method, the nozzle tip is first positioned adjacent to an alignment fixture. The nozzle tip has a first end and the alignment fixture has a second end. Then, a determination is made as to whether the first end of the nozzle tip is aligned with the second end of the alignment fixture such that an axis of the nozzle tip is collinear with an axis of the alignment fixture.

In yet another alternative method, the nozzle tip is positioned adjacent to an alignment bolt positioned in a stationary member. Then, a determination is made as to whether the nozzle tip is aligned with the alignment bolt such that an axis of the nozzle tip is collinear with an axis of the alignment bolt. If the axis of the nozzle tip is misaligned with the axis of the alignment bolt, the nozzle tip is adjusted such that the axis of the nozzle tip is aligned with the axis of the alignment bolt, or the nozzle tip is replaced with a second nozzle tip whose axis is aligned with the axis of the alignment bolt.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

FIG. 1 is a view of a vehicle undergoing a manufacturing process, which is useful to illustrate the methods described herein.

FIG. 2 is a view of the inner surface of a vehicle door.

FIG. 3A is a simplified view of a stationary member within a manufacturing work area, according to certain illustrative embodiments of the present disclosure.

FIG. 3B is a close-up view of a stationary member.

FIG. 3C shows a side view of an alignment fixture partially screwed into (i.e., the retracted position) the surface of a stationary member, according to certain illustrative embodiments of the present disclosure.

FIG. 4A is a simplified view of a robot in the manufacturing work area, according to certain illustrative embodiments of the present disclosure.

FIG. 4B is a close-up view of a robotic nozzle tip and arm.

FIG. 5A shows a robot being moved in the vicinity of a stationary member.

FIG. 5B shows a nozzle tip in the alignment position.

FIG. 5C shows an alignment bolt in the extended position (i.e., completely screwed into the stationary member).

FIG. 5D is a side view showing a nozzle tip in the alignment position with an alignment bolt in the extended position.

FIG. 6A shows a side view of an alignment bolt and nozzle tip.

FIG. 6B shows a view from below of a misaligned nozzle tip.

FIG. 6C shows a view from the front of another misaligned nozzle tip.

FIG. 7A shows a side view of a nozzle tip and alignment bolt in the extended position.

FIG. 7B shows another view from below the nozzle tip and alignment bolt.

FIG. 7C shows a view front view of an aligned nozzle tip, according to certain illustrative embodiments of the present disclosure.

FIG. 8 is a flow chart of a method to determine alignment of a nozzle tip on a robotic arm, according to certain illustrative methods of the present disclosure.

### DESCRIPTION OF ILLUSTRATIVE EMBODIMENTS

Illustrative embodiments and related methods of the present disclosure are described below as they might be employed in systems and methods to determine alignment of a nozzle tip on a robotic arm. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methods of the disclosure will become apparent from consideration of the following description and drawings.

As described herein, the present disclosure describes a system and method to easily and reliably verify a robot nozzle tip is aligned in the proper orientation with respect to the robot work environment. The described methods allow the nozzle tip to remain on the robot while it is being checked for alignment, thus ensuring the nozzle tip will have a high accuracy of application. Further, the methods ensure the nozzle tip is aligned in six degrees of freedom (e.g., X, Y, Z, rX, rY, and rZ), and also allows the user to easily align a misaligned nozzle tip. The cause of the misapplication issue can also be determined using the illustrative methods. If the robot is misapplying material, then the nozzle tip verification methods can be used to determine if the problem is nozzle misalignment or, if the nozzle tip is not misaligned, it shows the problem is elsewhere in the manufacturing process.

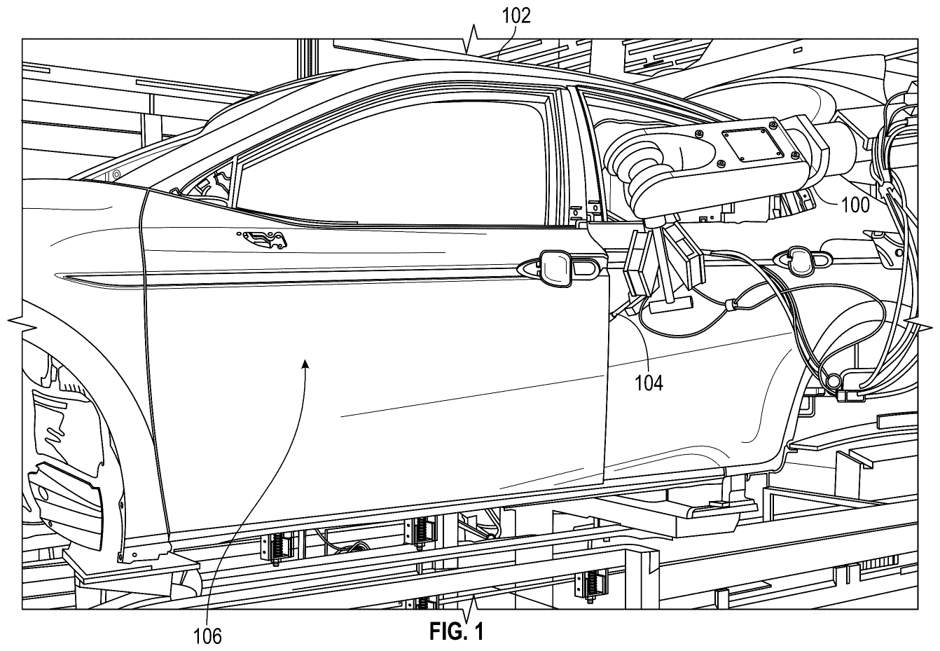

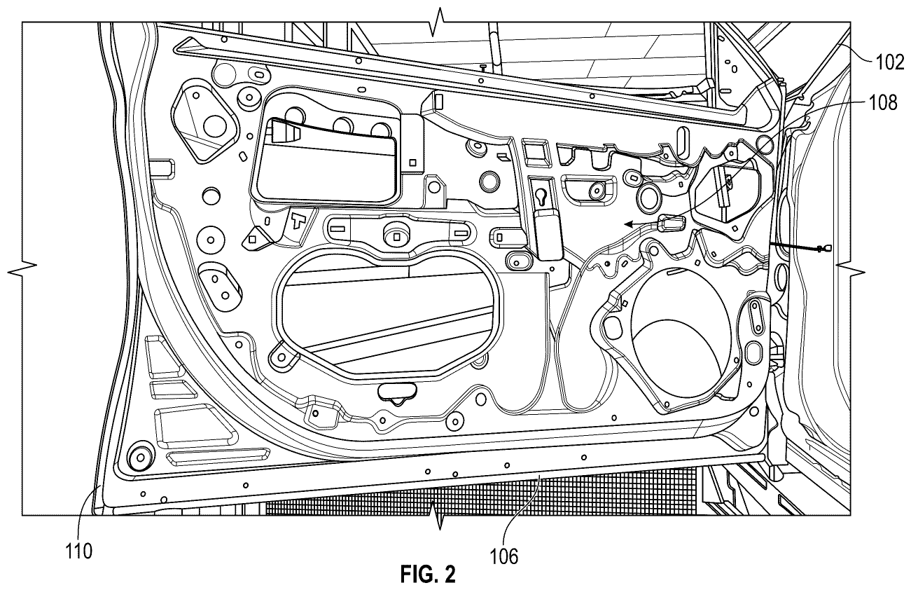

FIG. 1 is a view of a vehicle undergoing a manufacturing process, which is useful to illustrate the methods described herein. A robotic arm 100 is shown adjacent to a vehicle 102 being built during a manufacturing process. In this view, robotic arm 100 includes a nozzle tip 104 used to apply seal caulking to the inside surface of door 106. Door 106 is shown slightly ajar so that nozzle tip 104 can reach the inner surface of door 106. FIG. 2 is a view of the inner surface of vehicle door 106. Inner surface 108 includes a caulk line 110 which was applied by nozzle tip 104.

As described herein, often nozzle tip 104 can become hung up on the edge of door 106 or otherwise collide with door 106 or the exterior of vehicle 102. As a result, nozzle tip 104 can be deformed or otherwise moved from its original calibrated position. When this happens, nozzle tip 104 will then misapply caulk line 110, thereby resulting in a stalling of the manufacturing process and costly downtime to trouble shoot the issue. Embodiments and methods of the present disclosure are intended to alleviate these challenges.

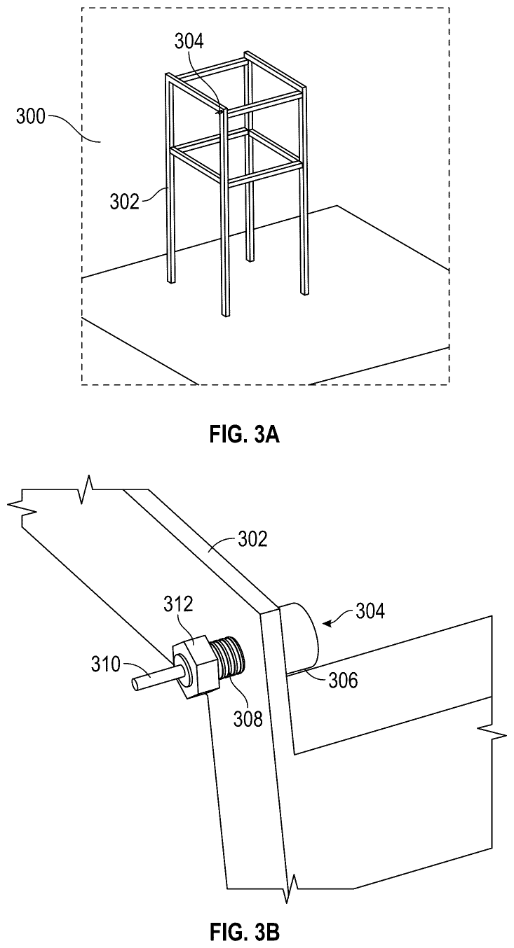

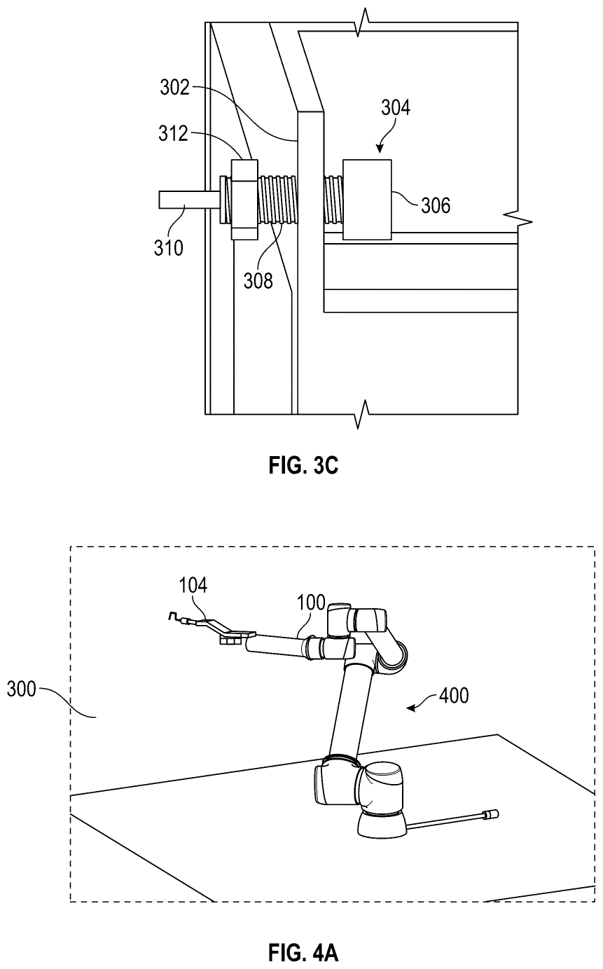

FIG. 3A is a simplified view of a stationary member within a manufacturing work area, according to certain illustrative embodiments of the present disclosure. A work area 300 includes a stationary member 302, which could take a variety of forms such as, for example, a metal stand, pole, or other stationary rigid member. In this example, stationary member 302 is affixed to the floor or a wall so that it does not move during calibration of nozzle tips, as described herein. Stationary member 302 also includes an alignment fixture 304 affixed thereto.

FIG. 3B is a close-up view of stationary member 302. In this view, the alignment fixture 304 is shown coupled to stationary member 302. In this example, alignment fixture 304 is a bolt threaded into stationary member. As will be described later, this view shows alignment fixture 304 in a retracted position (i.e., bolt 304 has not been completely screwed into stationary member 302). FIG. 3C shows a clearer side view of alignment fixture 304 partially screwed into (i.e., the retracted position) the surface of stationary member 302. As can be seen, alignment fixture 304 is a bolt having a head 306 with a threaded shaft body 308 extending therefrom. At the distal end of threaded shaft body 308 is an alignment shaft 310 which has a smaller diameter as compared to threaded shaft body 308. Further, bolt 304 may also include a lock-nut 312 positioned on the distal end of the threaded shaft body 308, which is used to prevent the bolt 304 from falling or being completely removed from the stationary member 302 while being moved to the retracted position or when in the retracted position.

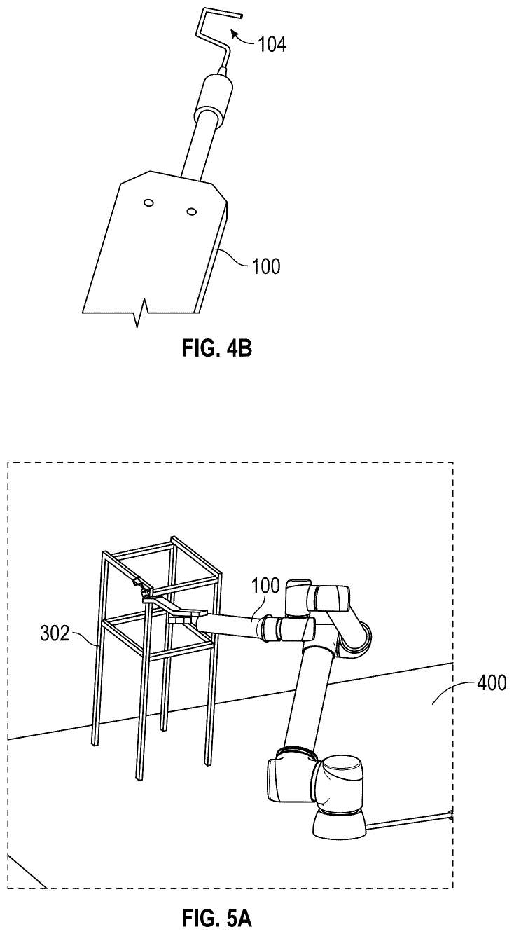

FIG. 4A is a simplified view of a robot in the manufacturing work area, according to certain illustrative embodiments of the present disclosure. Robot 400 can move throughout work area 300 as necessary to achieve its manufacturing objectives. A variety of such robots will be readily apparent to those ordinarily skilled in the art having the benefit of this disclosure. Robot 400 includes robotic arm 100 having nozzle tip 104 thereon. FIG. 4B is a close up view of nozzle tip 104 and arm 100.

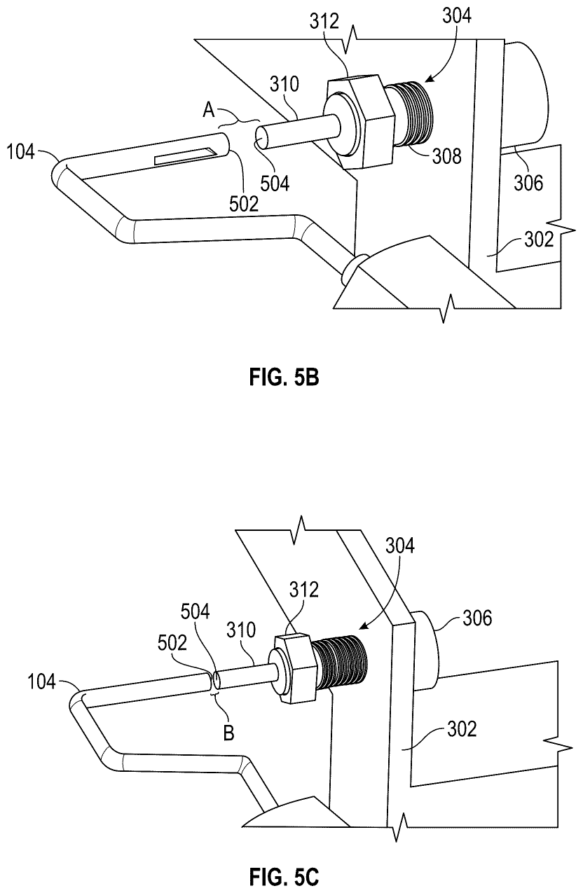

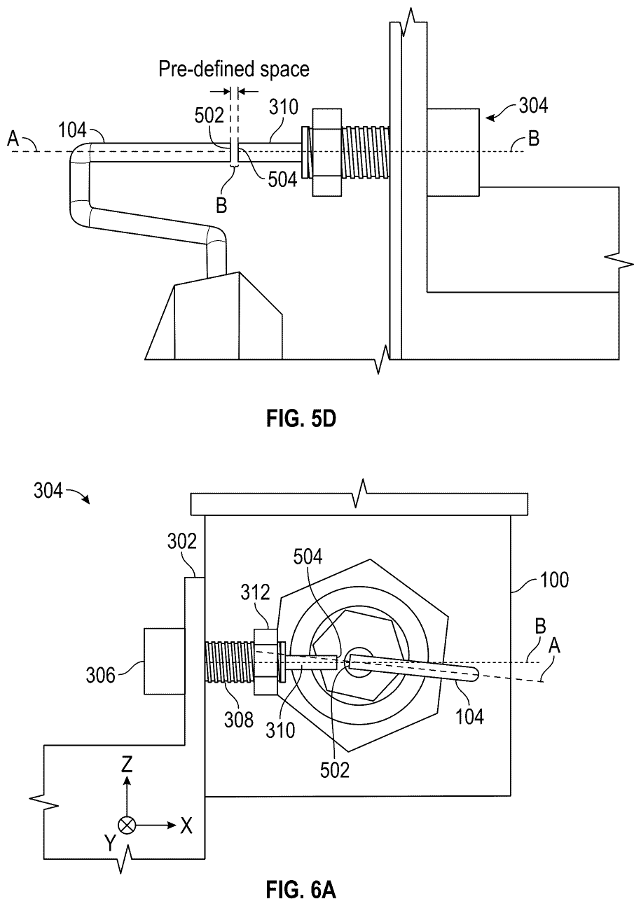

FIGS. 5A-5D are various views of nozzle tip 104 and alignment fixture 304 useful to illustrate the methods of the present disclosure. FIG. 5A shows a robot 400 being moved in the vicinity of stationary member 302. This movement may be achieved in a variety of ways. For example, an operator may initiate movement of robot 400 to a preconfigured tip alignment position that is saved into a robot program. This preprogrammed alignment position may be stored in memory of the robot 400. The movement may be initiated remotely or manually (e.g., push of a button) by an operator or some controller. This preprogrammed alignment position situates the nozzle tip 104 adjacent to the alignment fixture 304 secured to stationary member 302. The programmed position of nozzle tip 104 is the original, calibrated position necessary to ensure the caulk line 110 is applied correctly—and may be programmed into the robot upon initial setup. Thus, in instances when nozzle tip 104 is no longer positioned as originally intended, the alignment with alignment fixture 304 will be off, thereby allowing nozzle tip 104 to be re-aligned, as discussed below.

FIG. 5B shows nozzle tip 104 in the alignment position. Here, nozzle tip 104 is positioned directly in front of alignment fixture/bolt 304. Nozzle tip 104 has an end 502 and alignment shaft 310 has an end 504. Alignment bolt 304 is shown in the retracted position (not completely screwed into stationary member 302) which, as a result, creates a distance A between end 502 and end 504. Distance A may be any desired distance suitable to prevent collision between nozzle tip 104 and alignment bolt 304 while nozzle tip 104 is moved into the pre-programmed alignment position.

FIG. 5C shows alignment bolt 304 in the extended position (i.e., completely screwed into stationary member 302). In the extended position, a distance B is then present between end 502 or nozzle tip 104 and end 504 of alignment shaft 310. As can be seen, distance B is less than distance A. Note, in this example, alignment bolt is screwed into the extended position manually by an operator. In alternative embodiments, alignment bolt 304 can be automatically screwed into and out of the extended positioned using, for example, mechanical means.

FIG. 5D is a side view showing nozzle tip 104 in the alignment position with alignment bolt 304 in the extended position. Here, one can see distance B between ends 502 and 504 is 1 millimeter. However, in other examples, this space may be more or less. In some illustrative methods, when determining whether nozzle tip 104 is aligned properly, the distance B can be measured and compared against a predetermined distance B (e.g., taken when nozzle tip 104 is originally calibrated into the correct aligned position). Once it is determined distance B matches a pre-calibrated distance B, the operator (or system in the case of automated alignment) can then determine whether nozzle tip 104 is aligned.

Nevertheless, in this extended position, the operator verifies whether nozzle tip 104 is collinear to alignment bolt 304 at all angles and ensures there is a pre-defined amount of space (distance B) between end 502 and 504. As used herein, the alignment bolt and nozzle tip are “collinear” when the axes of both are not only parallel, but also pointing at one another/intersecting. In one example, the operator verifies nozzle tip 104 is aligned in up to six degrees of freedom: X, Y, Z, rX, rY and rZ. Here, it is determined whether axis A of nozzle tip 104 is collinear with axis B of alignment bolt 304. If axis A is not collinear with axis B, nozzle tip 104 is adjusted such that axis A is collinear with axis B. If nozzle tip 104 cannot be adjusted, it may be replaced. If axis A is determined to be collinear with axis B, the operator then knows there must be some misalignment issue in other parts of robot 100.

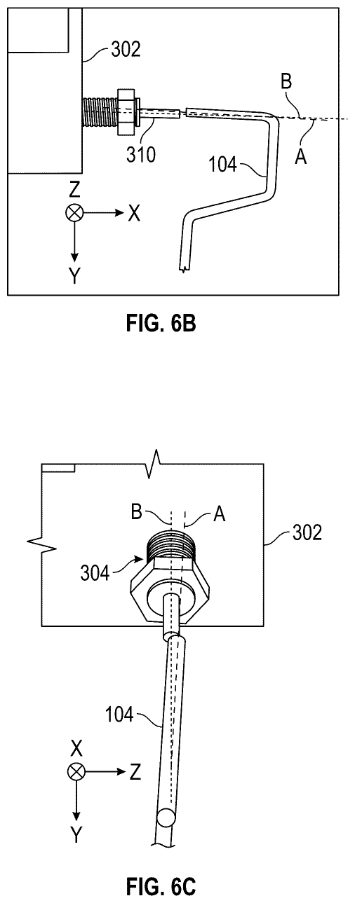

FIGS. 6A-6C show various views of a misaligned nozzle tip, according to certain illustrative embodiments of the present disclosure. FIG. 6A shows a side view of alignment bolt 304 and nozzle tip 104. Here, robot 400 (and robot arm 100) have been moved into the pre-programmed alignment position. Alignment bolt 304 has been put into the extended position. As can be seen, axis A of nozzle tip 104 and axis B of alignment shaft 310 are misaligned (not collinear to one another).

FIG. 6B shows a view from below of a misaligned nozzle tip. As can be seen, axis A of nozzle tip 104 is misaligned with axis B of alignment bolt 304. FIG. 6C shows a view from the front of another misaligned nozzle tip. Here, again, axis A of nozzle tip 104 is misaligned with axis B of alignment bolt 304.

A misaligned nozzle tip can be aligned in a variety of ways. For example, the operator may manually adjust the nozzle tip until its axis is aligned with the axis of alignment bolt 304. In other examples, nozzle tip 104 may be adjusted using some mechanical means, such as through use of a precision adjustment robot having suitable software, as will be understood by those ordinarily skilled in the art having the benefit of this disclosure. Regardless of the means used, in this example, nozzle tip 104 is adjusted until its axis is collinear to the axis of alignment bolt 304. In those instances when nozzle tip 104 may be too far misaligned to align it, nozzle tip 104 may be replaced with another nozzle tip whose axis does align with the axis of alignment bolt 304.

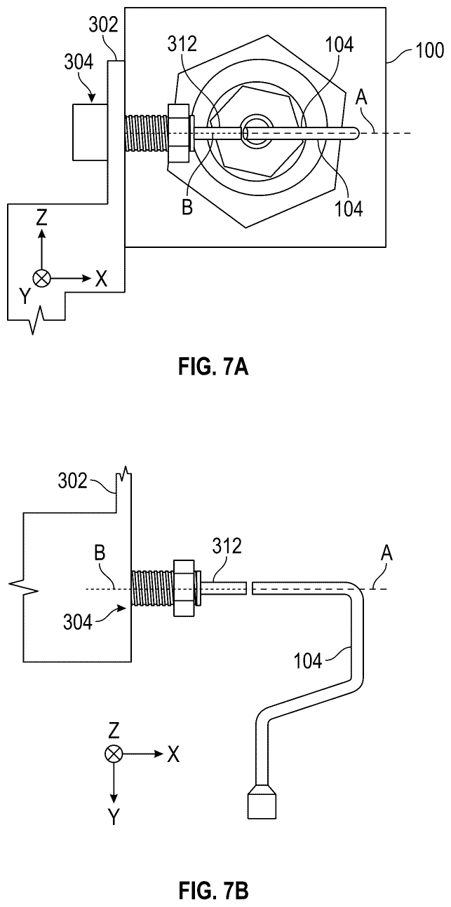

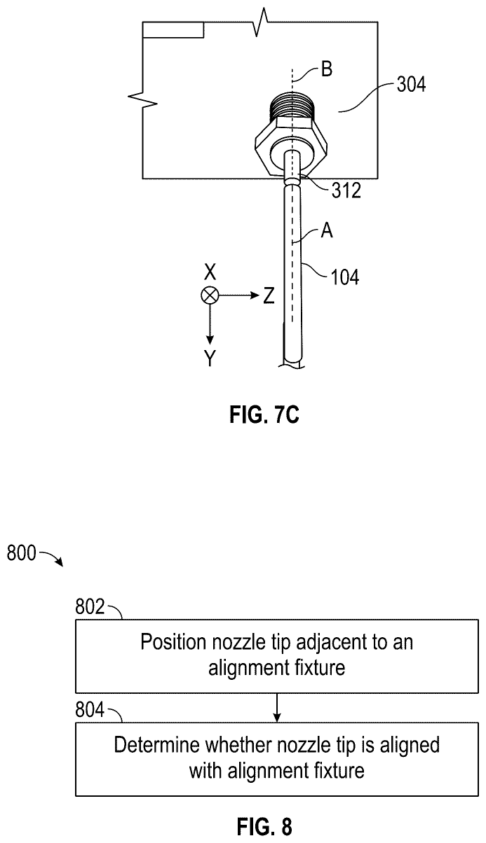

FIGS. 7A-C shows various views of an aligned nozzle tip, according to certain illustrative embodiments of the present disclosure. FIG. 7A shows a side view of nozzle tip 104 and alignment bolt 304 in the extended position in the Z-Y plane. As can be seen, axis A of nozzle tip 104 is aligned with axis B of alignment bolt 304. FIG. 7B shows another view from below of nozzle tip 104 and alignment bolt 304 in the X-Y plane. Here, again, axis A of nozzle tip 104 is aligned with axis B of alignment bolt 304. FIG. 7C shows a view front view of an aligned nozzle tip in the Z-Y plane, according to certain illustrative embodiments of the present disclosure. Here, axis A of nozzle tip 104 is collinear (aligned) with the axis B of alignment bolt 304. As can be seen in FIGS. 7A-7C, the nozzle tip and alignment bolt are aligned in the Z-X plane, X-Y plane and Z-Y plane, thus being collinear with one another.

FIG. 8 is a flow chart of a method to determine alignment of a nozzle tip on a robotic arm, according to certain illustrative methods of the present disclosure. Method 800 begins by positioning a nozzle tip adjacent to an alignment fixture, at block 802. Here, the nozzle tip has a first end and the alignment fixture has a second end. At block 804, it is determined whether the nozzle tip is aligned with the alignment fixture. Here, this determination may be made by determining whether the first end of the nozzle tip is aligned with the second end of the alignment fixture. To do so, the axis of the nozzle tip is analyzed to determine if it is collinear to the axis of the alignment fixture. As described herein, the determination of block 804 may be made manually by an operator on the manufacturing floor or using some suitable system designed to analyze the axes of the nozzle tip and alignment fixture.

As described herein, in block 802, the nozzle tip may be positioned adjacent to the alignment fixture by moving the robotic arm to a preconfigured nozzle tip alignment position. In certain illustrative embodiments, this movement may be activated using a push button or some other activation mechanism which moves the robot to a preprogrammed position used to calibrate the nozzle tip into the correct position.

Further, in yet other illustrative methods, in block 802, the first end of the nozzle tip is positioned a first distance from the end of the alignment fixture, which is the retracted position (for the alignment fixture). Thereafter, in block 804, the alignment fixture is positioned into the extended position as described herein, resulting in a second distance between the end of the nozzle tip and the end of the alignment position. Here, the second distance is less than the first distance. Next, an operator (or the system) verifies the second distance is a pre-defined, calibrated distance (which was defined when the nozzle tip was first calibrated into the proper position for applying the caulk line 110). In certain examples, an operator may verify this second distance using a measuring tool (e.g., ruler, caliper, insertion gauge, etc). While in other examples, a computerized system may verify this second distance using some measurement tool or algorithm.

Ultimately, if the axis of the nozzle tip is misaligned with the axis of the alignment fixture, the described methods provide at least two options. First, the nozzle tip can be aligned with the axis of the alignment fixture. This alignment may be done manually by an operator or automatically by some mechanized alignment system (e.g., a robot). Second, the nozzle tip can be replaced with a nozzle tip whose axis does align with the axis of the alignment fixture.

As described herein, various aspects of the present disclosure may be performed manually or using a processor. In those embodiments using processors, such processing capability may be implemented in a robotic system, other devices or workstations (e.g., third-party workstations, network routers, etc.), or on a cloud processor or other remote processing unit, as necessary to implement the methods described herein. The processor circuitry may include a processor, a memory having instructions thereon, and a communication module. These elements may be in direct or indirect communication with each other, for example via one or more buses.

The processor may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor may also comprise another hardware device, a firmware device, or any combination thereof configured to perform the operations described herein. The processor may also be implemented as a combination of computing devices, e.g., a combination of a DSP and a microprocessor, a plurality of microprocessors, one or more microprocessors in conjunction with a DSP core, or any other such configuration.

Embodiments of the present disclosure provide a variety of advantages. For example, the methods described herein provide the ability to quickly re-align the nozzle tip if it is out of alignment. As a result, the downtime (when a nozzle is bent) is greatly reduced (e.g., downtime can be reduced from 20 minutes on average, to 1 minute on average).

Furthermore, the illustrative methodologies described herein may be implemented by a system comprising processing circuitry or a non-transitory computer program product comprising instructions which, when executed by at least one processor, causes the processor to perform any of the methodology described herein.

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several example embodiments, while different steps, processes, and procedures are described as appearing as distinct acts, one or more of the steps, one or more of the processes, and/or one or more of the procedures may also be performed in different orders, simultaneously, and/or sequentially. In several example embodiments, the steps, processes and/or procedures may be merged into one or more steps, processes, and/or procedures.

In several example embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations. The phrase “at least one of A and B” should be understood to mean “A; B; or both A and B.” The phrase “one or more of the following: A, B, and C” should be understood to mean “A; B; C; A and B; B and C; A and C; or all three of A, B, and C.” The phrase “one or more of A, B, and C” should be understood to mean “A; B; C; A and B; B and C; A and C; or all three of A, B, and C.”

Although various embodiments and methods have been shown and described, the disclosure is not limited to such embodiments and methods and will be understood to include all modifications and variations as would be apparent to one skilled in the art. Therefore, it should be understood that embodiments of the disclosure are not intended to be limited to the particular forms disclosed. Rather, the intention is to cover all modifications, equivalents and alternatives falling within the spirit and scope of the disclosure as defined by the appended claims.

What is claimed is:

1. A method to determine alignment of a nozzle tip on a robotic arm, comprising:
moving the robotic arm to a pre-programmed alignment position, thereby positioning the nozzle tip adjacent to an alignment fixture secured to a stationary member,
wherein the nozzle tip has a first end and the alignment fixture has a second end, the alignment fixture being in a retracted position to thereby create a first distance between the first end of the nozzle tip and the second end of the alignment fixture to prevent collision between the nozzle tip and alignment fixture;
once the nozzle tip is positioned adjacent to the alignment fixture, extending the alignment fixture such that a second distance is placed between the first end of the nozzle tip and the second end of the alignment fixture, the second distance being less than the first distance; and
determining whether the first end of the nozzle tip is aligned with the second end of the alignment fixture such that an axis of the nozzle tip is collinear with an axis of the alignment fixture.

2. The method of claim 1, wherein the alignment fixture is a bolt extending through the stationary member.

3. The method of claim 1, wherein determining whether the first end of the nozzle tip is aligned with the second end of the alignment fixture comprises determining whether the second distance is equal to a pre-defined distance.

4. The method of claim 1, wherein, if the axis of the nozzle tip is misaligned with the axis of the alignment fixture, the method further comprises:
aligning the nozzle tip such that the axis of the nozzle tip is aligned with the axis of the alignment fixture; or
replacing the nozzle tip with a second nozzle tip whose axis is aligned with the axis of the alignment fixture.

5. The method of claim 1, wherein the nozzle tip is used in a vehicle manufacturing process.

6. A method to determine alignment of a nozzle tip on a robotic arm, comprising:
positioning the nozzle tip adjacent to an alignment fixture, the nozzle tip having a first end and the alignment fixture having a second end; and
determining whether the first end of the nozzle tip is aligned with the second end of the alignment fixture such that an axis of the nozzle tip is parallel with an axis of the alignment fixture.

7. The method of claim 6, wherein positioning the nozzle tip adjacent to the alignment fixture comprises moving the robotic arm to a preconfigured nozzle tip alignment position.

8. The method of claim 7, wherein the preconfigured nozzle tip alignment position is a pre-programmed position.

9. The method of claim 6, wherein the alignment fixture is a bolt extending through the stationary member.

10. The method of claim 6, wherein positioning the nozzle tip adjacent to the alignment fixture comprises:
positioning the first end of the nozzle tip a first distance from the second end of the alignment fixture,
wherein the alignment fixture is positioned in a retracted position.

11. The method of claim 10, wherein determining whether the first end of the nozzle tip is aligned with the second end of the alignment fixture comprises:
positioning the alignment fixture in an extended position resulting in a second distance between the first end of the nozzle tip and second end of the alignment fixture,
wherein the second distance is less than the first distance;
verifying the second distance is a pre-defined distance; and
determining whether the axis of the nozzle tip is aligned with the axis of the alignment fixture.

12. The method of claim 6, wherein, if the axis of the nozzle tip is misaligned with the axis of the alignment fixture, the method further comprises:
aligning the nozzle tip such that the axis of the nozzle tip is aligned with the axis of the alignment fixture; or
replacing the nozzle tip with a second nozzle tip whose axis is aligned with the axis of the alignment fixture.

13. The method of claim 6, wherein the nozzle tip is used in a vehicle manufacturing process.

14. A method to determine alignment of a nozzle tip on a robotic arm, comprising:
positioning the nozzle tip adjacent to an alignment bolt positioned in a stationary member;
determining whether the nozzle tip is aligned with the alignment bolt such that an axis of the nozzle tip is collinear with an axis of the alignment bolt; and
if the axis of the nozzle tip is misaligned with the axis of the alignment bolt:
adjusting the nozzle tip such that the axis of the nozzle tip is aligned with the axis of the alignment bolt; or
replacing the nozzle tip with a second nozzle tip whose axis is aligned with the axis of the alignment bolt.

15. The method of claim 14, wherein positioning the nozzle tip adjacent to the alignment fixture comprises moving the robotic arm to a preconfigured nozzle tip alignment position.

16. The method of claim 15, wherein the preconfigured nozzle tip alignment position is a pre-programmed position.

17. The method of claim 14, wherein positioning the nozzle tip adjacent to the alignment bolt comprises:
positioning a first end of the nozzle tip a first distance from a second end of the alignment bolt,
wherein the alignment bolt is positioned in a retracted position.

18. The method of claim 17, wherein determining whether the nozzle tip is aligned with the alignment bolt comprises:
screwing the alignment bolt into the stationary member resulting in a second distance between the first end of the nozzle tip and second end of the alignment bolt,
wherein the second distance is less than the first distance; and
determining whether the axis of the nozzle tip is aligned with the axis of the alignment bolt.

19. The method of claim 18, wherein determining whether the axis of the nozzle tip is aligned with the axis of the alignment bolt comprises verifying the second distance is equal to a predetermined distance.

20. The method of claim 14, wherein the nozzle tip is used in a vehicle manufacturing process.
